(19) United States
(12) Patent Application Publication
(10) Pub. No.: US 2014/0181973 A1
(43) Pub. Date: Jun. 26, 2014

(54) METHOD AND SYSTEM FOR DETECTING MALICIOUS APPLICATION

(71) Applicant: National Taiwan University of Science and Technology, (US)

(72) Inventors: Hahn-Ming Lee, New Taipei City (TW); Dong-Jie Wu, Taipei City (TW); Ching-Hao Mao, Taipei City (TW); Te-En Wei, Taipei City (TW)

(73) Assignee: National Taiwan University of Science and Technology, Taipei (TW)

(21) Appl. No.: 13/888,382

(22) Filed: May 7, 2013

(30) Foreign Application Priority Data
Dec. 26, 2012 (TW) 101150253

(51) Int. Cl. G06F 21/56

(52) U.S. Cl. CPC G06F 21/562
USPC 726/23

(57) ABSTRACT

A malicious applications detection method is provided. The method includes: extracting a plurality of static features from a manifest file and a de-compiled code respectively obtained from a plurality of training malicious applications (APK files) and a plurality of training benign applications (APK files); generating at least one malicious application group using a clustering algorithm and generating at least one benign application group; generating application detecting models respectively representing the malicious and benign application groups based on static features of the training malicious and benign applications in each malicious application group and each benign application group; extracting target static features from a target manifest file and a target de-compiled code of a target application; using a classification algorithm, the target static features, and the application detecting models to determine whether the target application belongs to the malicious application group; and generating a warning message when a determination result is positive.

### CROSS-REFERENCE TO RELATED APPLICATION

This application claims the priority benefit of Taiwan application serial no. 101150253, filed on Dec. 26, 2012. The entirety of the above-mentioned patent application is hereby incorporated by reference herein and made a part of this specification.

### BACKGROUND OF THE INVENTION

1. Field of the Invention

The invention relates to a method for detecting an application and particularly relates to a method and a system for detecting a malicious application installed on a mobile electronic device.

2. Description of Related Art

As the development of smartphones and tablets becomes popular, our life and these mobile electronic devices become closely connected. The popularity of smartphones and tablets pushes forward the development of the application industry.

Taking applications developed for the Android platform as an example, reverse engineering techniques for Android applications have matured in recent years, and some Android malicious applications have been repackaged and distributed into third-party application markets. For this reason, users may unwittingly download applications containing malicious codes, which cause personal information to be stolen. Most of the conventional malicious application detecting methods rely on known malicious codes or behaviors to perform detection and thus cannot successfully detect new variant malicious applications. Moreover, repackaged malicious applications look very similar to the benign applications, and the added malicious components mostly run in the background and therefore cannot be detected easily. In view of the above, it is necessary to develop a mechanism for effective detection and warning of malicious applications.

### SUMMARY OF THE INVENTION

Accordingly, the invention provides a method and a system for detecting a malicious application for quickly and effectively examining whether an application adapted for a mobile electronic device is malicious.

The invention provides a malicious application detecting method, including: collecting a plurality of training malicious applications (APK files) and a plurality of training benign applications (APK files); respectively obtaining a manifest file and a de-compiled code from each of training malicious applications and each of training benign applications, and extracting static features from each manifest file and each de-compiled code; generating at least one malicious application group based on training malicious applications using a clustering algorithm, and grouping training benign applications into at least one benign application group according to a classification rule designed by the application market, such as games, music, business, weather, shopping and so on; generating application detecting models that respectively represent the malicious and benign application groups according to static features of training malicious applications in each malicious application group and training benign applications in each benign application group; when a target application is received, obtaining a target manifest file and a target de-compiled code from the target application and extracting static features from the target manifest file and the target de-compiled code; using a classification algorithm, the target static features, and the malicious and benign application detecting models to determine whether the target application belongs to any of the malicious application groups; and generating a warning message if a determination result is positive.

From another aspect, the invention provides a malicious application detecting system, including a feature extracting unit, a clustering unit, and a determining unit. The feature extracting unit is configured for receiving a plurality of training malicious applications (APK files) and a plurality of training benign applications (APK files), respectively obtaining a manifest file and a de-compiled code from each of training malicious applications and each of training benign applications, and extracting static features from each manifest file and each de-compiled code. The clustering unit is coupled to the feature extracting unit for generating at least one malicious application group based on training malicious applications using a clustering algorithm and grouping at least one benign application group based on training benign applications by referring to a classification rule designed by the application market, such as games, music, business, weather, shopping and so on. Application detecting models that respectively represent the malicious and benign application groups are generated according to static features of training malicious applications in each malicious application group and training benign applications in each benign application group. The determining unit is coupled to the feature extracting unit and the clustering unit for controlling the feature extracting unit to obtain a target manifest file and a target de-compiled code from a target application when the target application is received and extracting target static features from the target manifest file and the target de-compiled code. The determining unit uses a classification algorithm, the target static features, and the malicious and benign application detecting models to determine whether the target application belongs to any of the malicious application groups, and generates a warning message when the target application belongs to one of the malicious application groups.

Based on the above, the invention utilizes various static features contained in the manifest file and the de-compiled code of the application to establish the malicious and benign application groups, so as to analyze the manifest file and the de-compiled code in the application of the target application and use the static features thereof to determine whether the target application is malicious. Therefore, the detection result is generated quickly and accurately without the source code of the target application.

To make the aforementioned and other features and advantages of the invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate exemplary embodiments of the invention and, together with the description, serve to explain the principles of the invention.

FIG. 1 is a block diagram showing a malicious application detecting system according to an embodiment of the invention.

FIG. 2 is an operation flowchart of a malicious application detecting system according to an embodiment of the invention.

FIG. 3 is a flowchart showing a malicious application detecting method according to an embodiment of the invention.

FIG. 4 is an operation flowchart showing a clustering unit according to an embodiment of the invention.

### DESCRIPTION OF THE EMBODIMENTS

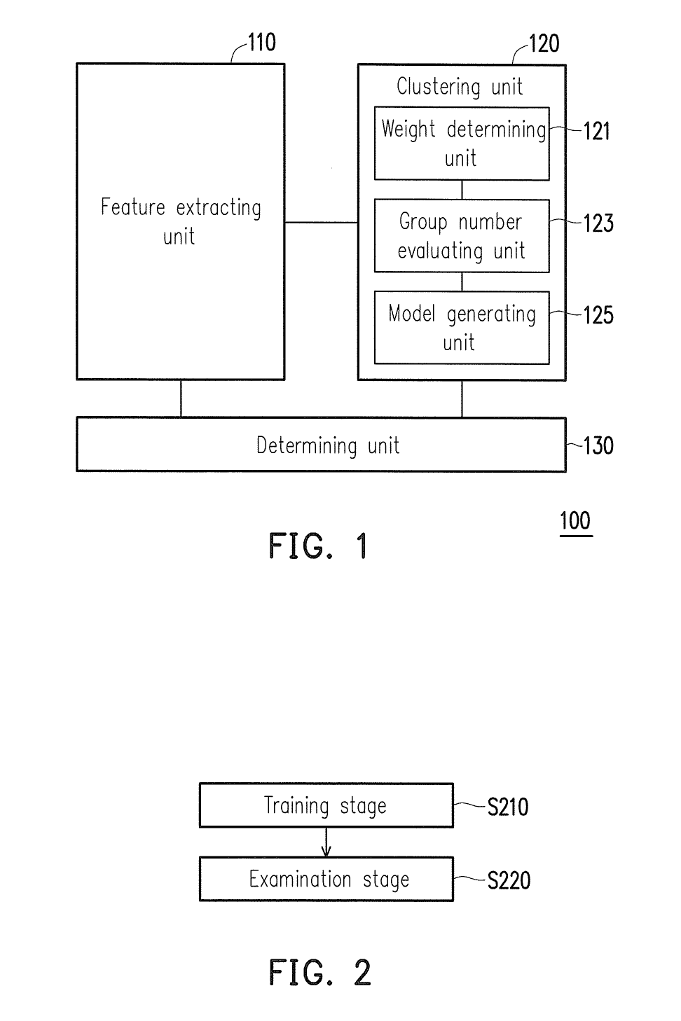

FIG. 1 is a block diagram showing a malicious application detecting system according to an embodiment of the invention. Referring to FIG. 1, a malicious application detecting system 100 includes a feature extracting unit 110, a clustering unit 120, and a determining unit 130. The clustering unit 120 includes a weight determining unit 121, a group number evaluating unit 123, and a model generating unit 125. Specifically, the feature extracting unit 110 is coupled to the clustering unit 120. The determining unit 130 is respectively coupled to the feature extracting unit 110 and the clustering unit 120.

The malicious application detecting system 100 determines whether an application contains any virus or malicious code mainly through static analysis. In particular, the malicious application detecting system 100 effectively detects the security of applications adapted for mobile electronic devices, so as to protect the mobile electronic devices. More specifically, the mobile electronic devices may include smartphones, personal digital assistants, or tablets, etc., and the applications are for example adapted for Android platform; however, the scope of the invention is not limited thereto.

In this embodiment, an operation of the malicious application detecting system 100 mainly includes two stages. Referring to FIG. 2, in a training stage as shown in Step S210, the malicious application detecting system 100, through operations of the feature extracting unit 110 and the clustering unit 120, establishes at least one benign application detecting model and at least one malicious application detecting model based on a plurality of training malicious applications (APK files) and a plurality of training benign applications (APK files) that are collected, for the determining unit 130 to analyze whether a target application is a malicious application in an examination stage as shown in Step S220.

It is worth mentioning that the feature extracting unit 110 of this embodiment extracts static features of a training application from a manifest file and a de-compiled code obtained from each of the training applications. According to static features, the clustering unit 120 generates the application detecting models for analyzing the applications. In other words, the malicious application detecting system 100 of this embodiment mainly utilizes the information provided by the manifest files and the de-compiled codes of the training applications to generate the malicious and benign application detecting models that are to be used in the examination stage.

In another embodiment, the malicious application detecting system 100 further includes a network unit (not shown). Accordingly, a user at a terminal device (e.g. a smartphone) may connect to the malicious application detecting system 100 through a network to examine specific applications.

The aforementioned units may be implemented in the form of hardware, software, or a combination of hardware and software. For example, the hardware may be a central processing unit (CPU), a programmable microprocessor for general use or special use, a digital signal processor (DSP), a programmable controller, an application specific integrated circuit (ASIC), any device capable of operation and processing, or a combination of the foregoing. The software may include an operation system, an application, or a driver.

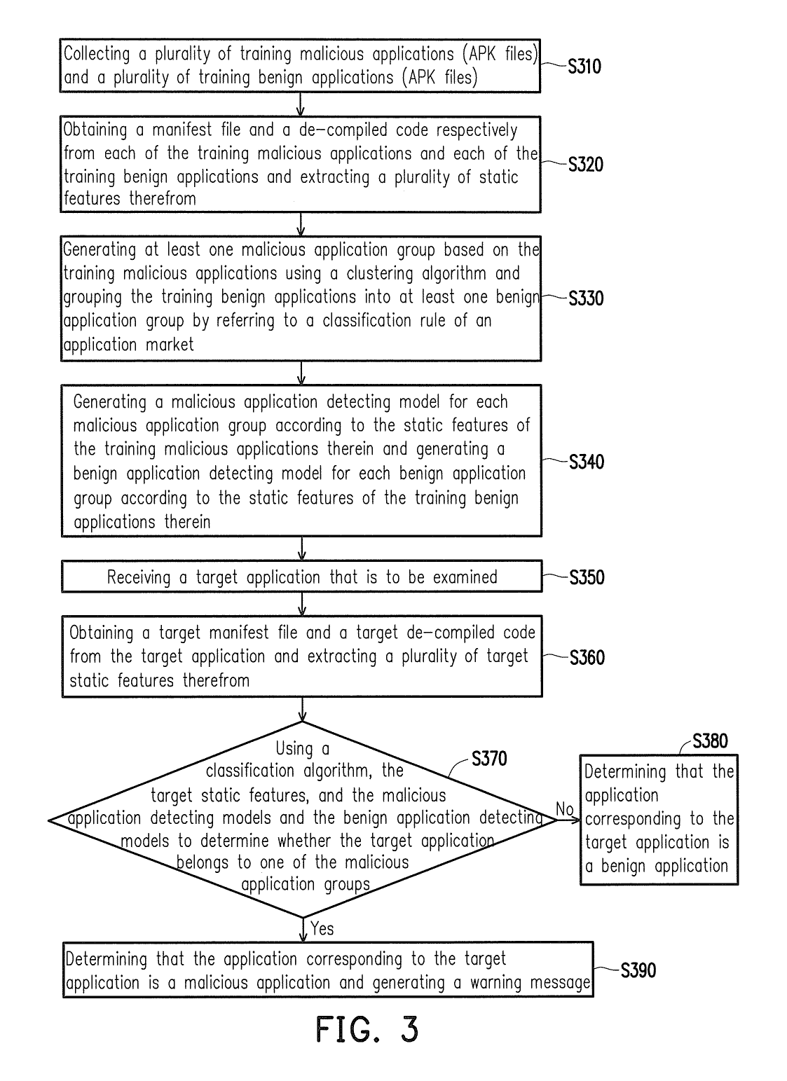

Detailed operation of each unit of the malicious application detecting system 100 is described below in another embodiment. FIG. 3 is a flowchart showing a malicious application detecting method according to an embodiment of the invention. Please refer to both FIG. 1 and FIG. 3.

In Step S310, the malicious application detecting system 100 collects a plurality of training applications (APK files). The training applications include several kinds of malicious applications (i.e. training malicious APK files) and several kinds of benign applications (i.e. training benign APK files).

Next, as shown in Step S320, the feature extracting unit 110 receives and reverse-engineers the collected training malicious applications and training benign applications, so as to obtain the manifest file and the de-compiled code respectively from each of the training malicious and benign applications and extract static features of applications corresponding to the training malicious and benign applications from the manifest files and the de-compiled codes. Specifically, the static features at least includes one of a Permission, a Component and a component type, an Intent, and an application interface (API) call, or a combination of the foregoing. The component type may be an activity, a service, a receiver, a provider, etc., for example.

In Step S330, the clustering unit 120 generates at least one malicious application group based on all training malicious applications using a clustering algorithm and groups at least one benign application group based on all training benign applications by referring to a classification rule designed by the application market, such as games, music, business, weather, shopping and so on. Further, in Step S340, the clustering unit 120 generates application detecting models that respectively represent the malicious and benign application groups according to static features of training malicious applications in each malicious application group and training benign applications in each benign application group. To be more specific, the clustering unit 120 presents all static features extracted by the feature extracting unit 110 in the form of vectors and utilizes the clustering algorithm to generate several malicious application groups respectively having similar static features. Moreover, the clustering unit 120 generates several benign application groups respectively having similar static features according to the classification rule designed by the application market, such as games, music, business, weather, shopping and so on. The malicious and benign application groups respectively correspond to specific application detecting models (i.e. malicious application detecting model and benign application detecting model, in brief). It should be noted that the clustering unit 120 may select an appropriate clustering algorithm according to the properties of the collected training applications.

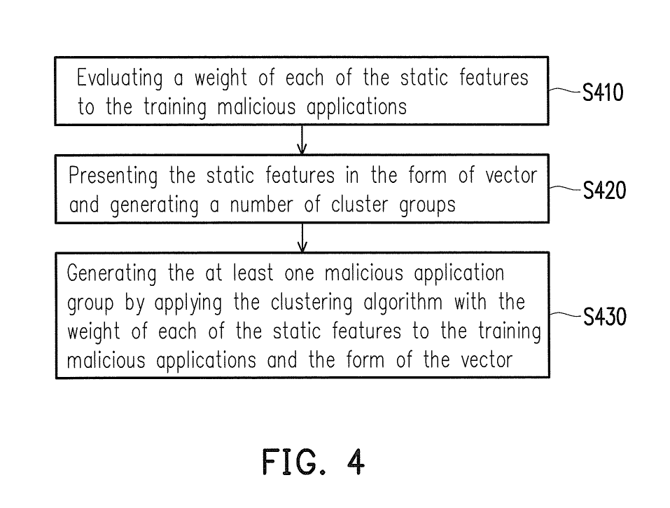

In the following paragraphs, the operation of the clustering unit 120 is explained with reference to FIG. 4. Please refer to FIG. 4.

First, as shown in Step S410, the weight determining unit 121 evaluates a weight of each of static features to training malicious applications. For example, for each training malicious application, the weight determining unit 121 gathers statistics about the number of times that each static feature appears in each training malicious application. For each static feature, the weight determining unit 121 gathers statistics about the number of training malicious applications that contain this static feature. In addition, the weight determining unit 121 utilizes a term frequency-inverse document frequency (TF-IDF) formula to calculate the weight of each static feature to each training malicious application. That is to say, the weight reflects the importance of each static feature.

Then, in Step S420, the group number evaluating unit 123 presents the static features of each training malicious application in the form of vector and generates a number of cluster groups. More specifically, the group number evaluating unit 123 calculates a plurality of eigenvalues according to a singular value decomposition (SVD) formula and obtains first N eigenvalues of the eigenvalues that cover a specific percentage of a spectral energy, and regards N as the number of cluster groups. Herein, the group number evaluating unit 123 calculates the eigenvalues and the spectral energies they covers from large to small, and obtains the first N eigenvalues that cover the total spectral energy for use with priority. It should be noted that N is a positive integer; however, according to the invention, N is not necessarily a fixed constant. N is determined by a value of the specific percentage. For instance, the specific percentage is 95%, but the scope of the invention is not limited thereto.

As shown in Step S430, the model generating unit 125 generates at least one malicious application group by applying the clustering algorithm with the weight of the static features of each training malicious application and the vector form. All training malicious applications that belong to the same malicious application group have similar static features. For training benign applications of the benign application group, the model generating unit 125 groups training benign applications into at least one benign application group according to the classification rule of the application market, such as games, music, business, weather, shopping and so on.

Step S310 to Step S340 of FIG. 3 belong to the training stage of the malicious application detecting system 100. When the malicious application detecting system 100 enters the examination stage at a later date, that is, when the user wants to examine a target application, the user may upload the target application to the malicious application detecting system 100 through the network. The malicious application detecting system 100 then examines the security of the target application using the benign and malicious application detecting models generated in the training stage.

More specifically, referring to Step S350 of FIG. 3, the determining unit 130 receives the target application that is to be examined and, in Step S360, controls the feature extracting unit 110 to obtain a target manifest file and a target de-compiled code from the target application and then extract target static features from the target manifest file and the target de-compiled code. The target static features may include at least one of a Permission, a Component and a component type, an Intent, and an application interface (API) call, or a combination of the foregoing. The component type may be an activity, a service, a receiver, a provider, etc., for example.

Thereafter, in Step S370, the determining unit 130 uses a classification algorithm, the target static features extracted by the feature extracting unit 110, and the malicious and benign application detecting models generated by the clustering unit 120 to determine whether the target application belongs to one of the malicious application groups.

If the target application does not belong to any of the malicious application groups, the determining unit 130 determines that the application corresponding to the target application is a benign application, as shown in Step S380.

On the contrary, if the target application belongs to one of the malicious application groups, the determining unit 130 determines that the application corresponding to the target application is a malicious application and generates a warning message, as shown in Step S390.

As illustrated in FIG. 3, the malicious application detecting system 100 establishes the malicious and benign application detecting models for examination based on the manifest files and the de-compiled codes obtained from the applications. When examining a target application, the malicious application detecting system 100 only requires the application of the target application, instead of the complete source code, for obtaining the information (from the manifest file and the de-compiled code of the target application) for analysis.

In conclusion of the above, the malicious application detecting method and system of the invention utilize static features, e.g. Permission, Component and component type, Intent, and API call, provided by the manifest file and the de-compiled code of the application, to generate the models for examination. Accordingly, when examining the security of the application, the analysis is accomplished simply based on the compiled application without the source code of the application. Additionally, the examination procedure performed based on static analysis does not occupy much system resources and thus the analysis result is generated more efficiently and more accurately.

It will be apparent to those skilled in the art that various modifications and variations can be made to the disclosed embodiments without departing from the scope or spirit of the invention. In view of the foregoing, it is intended that the invention covers modifications and variations of this disclosure provided that they fall within the scope of the following claims and their equivalents.

What is claimed is:

1. A malicious application detecting method, comprising:
collecting a plurality of training malicious applications (APK files) and a plurality of training benign applications (APK files);
obtaining a manifest file and a de-compiled code respectively from each of the training malicious applications and each of the training benign applications, and extracting a plurality of static features from each manifest file and each de-compiled code;
generating at least one malicious application group based on the training malicious applications using a clustering algorithm, and grouping the training benign applications into at least one benign application group according to a classification rule designed by an application market, wherein for each of the at least one malicious application group, generating a malicious application detecting model representing the malicious application group according to the static features of the training malicious applications in the malicious application group, and for each of the at least one benign application group, generating a benign application detecting model representing the benign application group according to the static features of the training benign applications in the benign application group;
receiving a target application;
obtaining a target manifest file and a target de-compiled code from the target application, and extracting a plurality of target static features from the target manifest file and the target de-compiled code;
determining whether the target application belongs to any of the at least one malicious application group according to a classification algorithm, the target static features, the malicious application detecting model of each of the at least one malicious application group, and the benign application detecting model of each of the at least one benign application group; and
generating a warning message if the target application belongs to one of the at least one malicious application group.

2. The malicious application detecting method according to claim 1, wherein the static features comprises at least one of a Permission, a Component and a component type, an Intent, and an application interface (API) call, or a combination of the foregoing.

3. The malicious application detecting method according to claim 1, wherein the step of generating the at least one malicious application group based on the training malicious applications using the clustering algorithm, and grouping the training benign applications into the at least one benign application group according to the classification rule designed by the application market, and for each of the at least one malicious application group, generating the malicious application detecting model representing the malicious application group according to the static features of the training malicious applications in the malicious application group, and for each of the at least one benign application group, generating the benign application detecting model representing the benign application group according to the static features of the training benign applications in the benign application group comprises:
evaluating a weight of each of the static features to the training malicious applications;
presenting the static features of each of the training malicious applications in a form of a vector and generating a number of cluster groups; and
generating the at least one malicious application group by applying the clustering algorithm with the weight of each of the static features to the training malicious applications and the form of the vector, wherein the training malicious applications that belong to the same malicious application group have similar static features.

4. The malicious application detecting method according to claim 3, wherein the step of evaluating the weight of each of the static features to the training malicious applications comprises:
for each of the training malicious applications, gathering statistics about the number of times that each of the static features appears in the training malicious applications;
for each of static features, gathering statistics about the number of the training malicious applications that comprise the static features; and
calculating the weight of each of the static features to each of the training malicious applications according to a term frequency-inverse document frequency (TF-IDF) formula.

5. The malicious application detecting method according to claim 3, wherein the step of presenting each of the static features in the form of the vector comprises:
calculating a plurality of eigenvalues according to a singular value decomposition (SVD) formula; and
obtaining first N eigenvalues of the plurality of eigenvalues that cover a specific percentage of a spectral energy, and regarding N as the number of cluster groups, wherein N is a positive integer.

6. A malicious application detecting system, comprising:
a feature extracting unit receiving a plurality of training malicious applications (APK files) and a plurality of training benign applications (APK files), obtaining a manifest file and a de-compiled code respectively from each of the training malicious applications and each of the training benign applications, and extracting a plurality of static features from each manifest file and each de-compiled code;
a clustering unit coupled to the feature extracting unit for generating at least one malicious application group based on the training malicious applications using a clustering algorithm, and grouping the training benign applications into at least one benign application group according to a classification rule designed by an application market, wherein for each of the at least one malicious application group, the clustering unit generates a malicious application detecting model representing the malicious application group according to the static features of the training malicious applications in the malicious application group, and for each of the at least one benign application group, the clustering unit generates a benign application detecting model representing the benign application group according to the static features of the training benign applications in the benign application group; and
a determining unit coupled to the feature extracting unit and the clustering unit for controlling the feature extracting unit to obtain a target manifest file and a target de-compiled code from a target application when the target application is received and extracting a plurality of target static features from the target manifest file and the target de-compiled code,
wherein the determining unit determines whether the target application belongs to any of the at least one malicious application group according to a classification algorithm, the target static features, the malicious application detecting model of each of the at least one malicious application group, and the benign application detecting model of each of the at least one benign application group, and generates a warning message when determining that the target application belongs to one of the at least one malicious application group.

7. The malicious application detecting system according to claim 6, wherein the static features comprises at least one of a Permission, a Component and a component type, an Intent, and an application interface (API) call, or a combination of the foregoing.

8. The malicious application detecting system according to claim 6, wherein the clustering unit comprises:
a weight determining unit evaluating a weight of each of the static features to the training malicious applications;
a group number evaluating unit coupled to the weight determining unit and presenting the static features of each of the training malicious applications in a form of a vector and generating a number of cluster groups; and
a model generating unit coupled to the group number evaluating unit and generating the at least one malicious application group by applying the clustering algorithm with the weight of each of the static features to the training malicious applications and the form of the vector, wherein the training malicious applications that belong to the same malicious application group have similar static features.

9. The malicious application detecting system according to claim 8, wherein the weight determining unit gathers statistics about the number of times that each of the static features appears in the training malicious applications for each of the training malicious applications, gathers statistics about the number of the training malicious applications that comprise the static feature for each of static features, and calculates the weight of each of the static features to each of the training malicious applications according to a term frequency-inverse document frequency (TF-IDF) formula.

10. The malicious application detecting system according to claim 8, wherein the group number evaluating unit calculates a plurality of eigenvalues according to a singular value decomposition (SVD) formula and obtains first N eigenvalues of the plurality of eigenvalues that cover a specific percentage of a spectral energy, and regards N as the number of cluster groups, wherein N is a positive integer.
